(19) United States
(12) Patent Application Publication
(10) Pub. No.: US 2015/0112723 A1
(43) Pub. Date: Apr. 23, 2015

(54) Specialty Medication Management and Referral Tracking System

(71) Applicant: Therigy, LLC, Maitland, FL (US)

(72) Inventors: Duane Holt, Altamonte Springs, FL (US); Joseph Morse, Winter Park, FL (US)

(21) Appl. No.: 14/520,325

(22) Filed: Oct. 21, 2014

Related U.S. Application Data
(60) Provisional application No. 61/961,703, filed on Oct. 21, 2013.

(51) Int. Cl. G06F 19/00

(52) U.S. Cl. CPC G06F 19/328; G06F 19/322
USPC 705/3

(57) ABSTRACT

Disclosed herein is a prescription referral management and tracking system and methods. The system combines the creation of the prior authorization, creation of the specialty medication referral, transmission of an e-prescription to a pharmacy, and creation of patient financial assistance forms into a single data entry session. The system is simple in form and design, eliminating complicated form storage and retrieval systems based on different classes of specialty drugs.

### BACKGROUND

Prior authorization of prescription medications is a process that involves the need to obtain authorization from a patient's insurance company before the insurance company will decide if it will pay for the medication. Prior authorization is usually required for expensive specialty medications, medications with age limits, drugs used for cosmetic reasons, or drugs prescribed to treat non-life threatening medical conditions. Other situations where prior authorization is required is where a doctor believes a medication is necessary but not usually covered by the insurance carrier, or where the prescription requires a higher than normal dosage.

The successful acquisition of prior authorization is a complicated process that involves many different parties, forms and information that must be coordinated. The Prior authorization process can lead to frustrations for the patient, pharmacy and prescribing physician. From a medical perspective, the prior authorization process can cause delays in treatment for days, which can have severe consequences on the medical outcome.

### SUMMARY

Disclosed herein is a Specialty Medication Management and Referral Tracking System to be used for creating, and electronically transmitting and tracking prescription referrals for specialty medications sent to pharmacies. Although there are other systems that can transmit prescriptions to pharmacies, there are various aspects of system embodiments that are superior and address drawbacks to current systems:
Provides for detailed tracking of a prescription referral within the system once the physician has transmitted the referral to the pharmacy.
consolidates the tracking information into one system, regardless of the number of pharmacies that may be recipients of prescription referrals
allows the creation of prior authorization forms that may be required by the patient's insurance, as part of the prescription referral process before the prescription is transmitted to a pharmacy
combines the creation of the prior authorization, creation of the specialty medication referral, transmission of an e-prescription to a pharmacy, and creation of patient financial assistance forms into a single data entry session
is simple in form and design, eliminating complicated form storage and retrieval systems based on different classes of specialty drugs
eliminates the duplicate (hand or electronic) entry of data on multiple forms
allows custom forms and multiple forms to be combined into a single form for storage in a patient electronic medical record system, and during the referral process to simultaneously create and transmit only the appropriate portions of the forms to third parties, complying with HIPAA's minimal use requirements, without additional work on the user's part to create a separate transmission
provides more timely and accurate information to a pharmacy concerning a patient's health than a typical e-prescription
may eliminate multiple calls between the pharmacy and physician's office to collect information that has been collected and transmitted during the referral creation process
may significantly speed up the Time To Fill* for a patient requiring drugs critical to their health (*Time To Fill being the time between a physician's decision to prescribe a drug therapy, and the time a pharmacy ships the drug for use by the patient) by:
   Completing the prior authorization processes earlier in the prescription fulfillment process, potentially days earlier,
   Providing patient financial assistance information at the time of prescribing,
   Reducing or eliminating wait times between when the pharmacy and physician communicate by fax, phone messaging, etc. by collecting more patient information relevant to the patient's therapy, by containing more business rules than a generic e-prescription can provide, and more data entry rules such as required fields, than a specialized paper form.

### BRIEF DESCRIPTION OF THE DRAWINGS

FIG. 1 is a flowchart of the steps a user or physician must progress through to complete a prescription referral and transmit the resulting information to third parties and save the same into persistent storage available within system.

FIG. 2 is a flowchart of system's decision support system and processes to identify the appropriate forms, data collection fields, and present the data collection fields on the user's screen for input and completion the by the user.

FIG. 3 represents flow diagrams of prescription referrals for specialty medications using a system embodiment provided herein.

FIG. 4 shows a architecture of a system embodiment and its interactivity with various interactive or supportive systems.

### DETAILED DESCRIPTION

As will be appreciated by one of skill in the art, embodiments of the present invention may be embodied as a device or system comprising a processing module, and/or computer program product comprising at least one program code module. Accordingly, the present invention may take the form of an entirely hardware embodiment or an embodiment combining software and hardware aspects. Furthermore, the present invention may include a computer program product on a computer-usable storage medium having computer-usable program code means embodied in the medium. Any suitable computer readable medium may be utilized including hard disks, CD-ROMs, DVDs, optical storage devices, or magnetic storage devices.

The term “processing module” may include a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The processing module may have operationally coupled thereto, or integrated therewith, a memory component. The memory component may be a single memory component or a plurality of memory components. Such a memory component may be a read-only memory (ROM), random access memory (RAM), volatile memory, non-volatile memory, static memory, dynamic memory, flash memory, an erasable programmable read-only memory (EPROM or Flash memory), an optical fiber, and a portable compact disc read-only memory (CD-ROM), a CD ROM, a DVD (digital video disk),and/or any other electronic device that stores digital information.

A “computer” or “computer unit”, as used herein, is intended to include at least one device that comprises at least one processing module (e.g. processor). In a typical embodiment, a computer unit includes at least one processing module, a memory component, and circuitry connecting the at least one processing module and said memory component in a housing. Optionally, the computer unit includes a computer readable medium and circuitry connecting the processing module and computer readable medium. A computer unit is also intended to include two or more computer units hardwired together.

The computer-usable or computer-readable medium may be or include, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM), a CD ROM, a DVD (digital video disk), or other electronic storage medium.

The term “communicatingly connected” means that one-way or two-way conveyance or communication of information. Typically, information is electronic information that is conveyed through a wired connection or transmitted wirelessly. Two different computer units may be communicatingly connected, a computer unit and a peripheral device (e.g. printer) and/or components of a computer unit may be communicatingly connected (e.g., a processing module may be communicatingly connected to memory component. Communicatingly connected may also include conveyance of information via a network (e.g. internet) to a remote computer. Conveyance of information may include transference of an electronic record, such as transfer of an email or email attachment or transfer of a file via a network. Conveyance of information may include transference of a facsimile file to a facsimile computer unit.

Computer program code for carrying out operations of certain embodiments of the present invention may be written in an object oriented and/or conventional procedural programming languages including, but not limited to, Java, Smalltalk, Perl, Python, Ruby, Lisp, PHP, “C”, FORTRAN, or C++. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Certain embodiments of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer-readable program code modules. These program code modules may be provided to a processing module of a general purpose computer, special purpose computer, embedded processor or other programmable data processing apparatus to produce a machine, such that the program code modules, which execute via the processing module of the computer or other programmable data processing apparatus, create means for implementing the functions specified in the flowchart and/or block diagram block or blocks.

These computer program code modules may also be stored in a computer-readable memory that can direct a computer or other programmable data processing apparatus to function in a particular manner, such that the program code modules stored in the computer-readable memory produce an article of manufacture.

The computer program code modules may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart and/or block diagram block or blocks.

The term “input component” as used herein refers to a component that delivers information to a computer such as a human interface device (e.g. keyboard, tracking device (such as a computer mouse), scanner, joystick or camera, touch-sensitivity in screen, microphone for voice commands) . Input component also pertains to circuitry configured to provide wired or wireless connectivity with another device to convey information automatically without user manipulation.

The term “patient” or “subject” as used herein refers to a human or non-human animal.

It should be noted that the terms “may,” “might,” “can,” and “could” are used to indicate alternatives and optional features and only should be construed as a limitation if specifically included in the claims. Claims not including a specific limitation should not be construed to include that limitation.

It should be noted that, unless otherwise specified, the term “or” is used in its nonexclusive form (e.g. “A or B” includes A, B, A and B, or any combination thereof, but it would not have to include all of these possibilities). It should be noted that, unless otherwise specified, “and/or” is used similarly (e.g. “A and/or B” includes A or B or A and B, or any combination thereof, but it would not have to include all of these possibilities). It should be noted that, unless otherwise specified, the term “includes” means “comprises” (e.g. a device that includes or comprises A and B contains A and B but optionally may contain C or additional components other than A and B). It should be noted that, unless otherwise specified, the singular forms “a,” “an,” and “the” refer to one or more than one, unless the context clearly dictates otherwise.

In certain embodiments, provided is a system that involves implementation of a program, executed on a local computer or through two or more computers communicatingly connected over a network, that performs user authentication, human interaction including data collection, data storage, data and form creation, and with some mandatory and optional interconnected systems for transmitting and receiving data from other systems. In a specific embodiment, the system requires the user authentication to be completed first on a device that can support encrypted communications between the user and the other system components. The system typically involves a database with a persistent storage medium that will maintain data in an electronic format with or without power supplied to the storage device. Ideally the storage medium is local (close proximity) of system disks of sufficient size and speed to assure the system's overall performance is acceptable to all users of the system. A computer engineer or other practitioner of the arts would typically be needed to configure the actual program and data storage to meet this requirement, and as new technologies are introduced the exact storage medium may change.

The system's database is loaded with forms, typically in PDF format, with form field placeholders, each form field with a special marker indicating the type and function the field's data represents. Each form also has associative metadata within the data storage medium indicating the type of form, its purpose, and its matching criteria to be used when the user is performing data entry in order to trigger the form's completion by the user. The system will use the database to store application configuration as well as connectivity information for third party system connections.

A connection may be implemented to perform the patient eligibility lookup for commercial insurance or government insurance. Currently this lookup is described in the art as a standard healthcare transaction E1. The database and application is also configured to transmit and receive electronic prescriptions, ideally as the NCPDP SCRIPT standard. As is true for most standards, as long it is either mandated (such as in HIPAA, or government initiatives such as meaningful use) then this is the preferred method for transmitting and receiving the eligibility lookup information and any one skilled in the art may use the public standard for implementation. The system also can connect to a Fax service that can send fax transmissions of completed forms to a phone number associated with a destination in the database. Interconnecting fax services with applications is a well-known and documented process by multiple vendors specializing in this service. Optionally the system can be interconnected to physician EMR systems with standard interfaces such as HL7, and to pharmacy systems through HL7, file transfer via sftp, web services, or other APIs, for retrieval of pharmacy status information as the prescription is dispensed. In the case of status data received the by the system, the system uses metadata and transformation tables to normalize the multitude status into a singular meaningful status appropriate for display within a physician's office.

To complete a referral for specialty medication, the user may access the system using a pre-defined account with secure credentials. These credentials would be required to meet current regulations in the U.S. to protect parties privacy, and would be typically implemented. Once the user has access to the system, the user may access the new referral screen through a human interface device that indicates their intent to prescribe a medication for a patient (such as, but not limited to a mouse click, keyboard data entry, touch screen click, or voice command, or other input in the industry known as a human input device). The user will be presented a referral data entry screen, with a set of data elements recognizable to a healthcare practitioner to complete. When the user enters patient demographic data prerequisite to support an eligibility lookup (E1 transaction), the system will perform the eligibility lookup. The user will be presented with the result of the E1 lookup which details the current insurance benefits for the patient. As data entry progresses, the system analyzes the data and will present additional data fields based on the matching criteria for additional form completion. The prerequisite elements and the matching criteria for each of the data elements to match a particular form are configurable as part of the system rules.

Drug selection and insurance information and other information may be analyzed by the system to retrieve the patient's insurance prior authorization form, data elements, and business rules. This may be accomplished by performing a search in a persistent data storage medium available to the system such as a database stored on disk or as a live transaction if such a service exists for the matching insurance. Additionally, as data entry continues, patient financial assistance forms, data elements, and rules may be loaded and used to populate the screen with new data entry elements. To e-prescribe, the user typically may need to select a pharmacy capable of receiving an ePrescription from the connected ePrescribe network. An ePrescribe network is a network of pharmacies with capability of connecting to a central network switch and sending and receiving prescriptions electronically. When the data entry is complete, the user will continue to confirm the data entry, and the prescribing's physician's intent to prescribe the drug as entered as well as to transmit the information to third parties. Upon the confirmation, the system will generate each form individually, and combine forms for transmission to each selected pharmacy and/or insurance (and any indicated third party in which the system can communicate by any means), and if eligible will submit a standard NCPDP SCRIPT formatted electronic prescription to the pharmacy. Upon confirmation by the user, the files are transmitted to the appropriate destinations, and the Eprescription electronically. After transmission the users can download individual PDF files of their records, or the combined PDF to print for a paper chart or storage in another electronic record system, or for future transmission to a third party. Not depicted on the illustrations, users can access the system to retrieve status information sent by pharmacies back through to the system for referral status tracking. The referral status tracking can be viewed in report format, dashboards (meaning singular break out of each item, or aggregated information over time, alerts for items that have been flagged by the rules engine as actionable vs. informational, or on individual patient records.

Alternate embodiments of the system can be described below:
Cloud implementations with separate database and application layers
Middleware components to compartmentalize the transmission and receipt of data to and from the system for each of transactions
Alternate graphics and skins to support white box branding
Custom implementations with fixed business rules for the referral data collection rather than metadata rules where the fixed business rules override any meta data rules
Custom form types for the referral form to support specific prescribing circumstances such as REMS, state board requirements, or pharmacy specific rules (settlements from enforcement actions, Custom form types can be individually or collectively related to the destination pharmacy or fulfillment destination, drug manufacturer, or FDA/and or State/Territory regulation affecting the class, type or specific drug required by regulatory bodies)
Multi device support with a responsive design or as separate application layers with localized databases for some or all of the data and metadata, such as those to support tablets, phones, and traditional computer display input/output devices
Partitioned application service layers across multiple cloud devices
Partitioned database layers for persistent storage
Direct connectivity to a pharmacy rather than connectivity through an ePrescribe or other network.

### NON-LIMITING ILLUSTRATIVE EMBODIMENTS

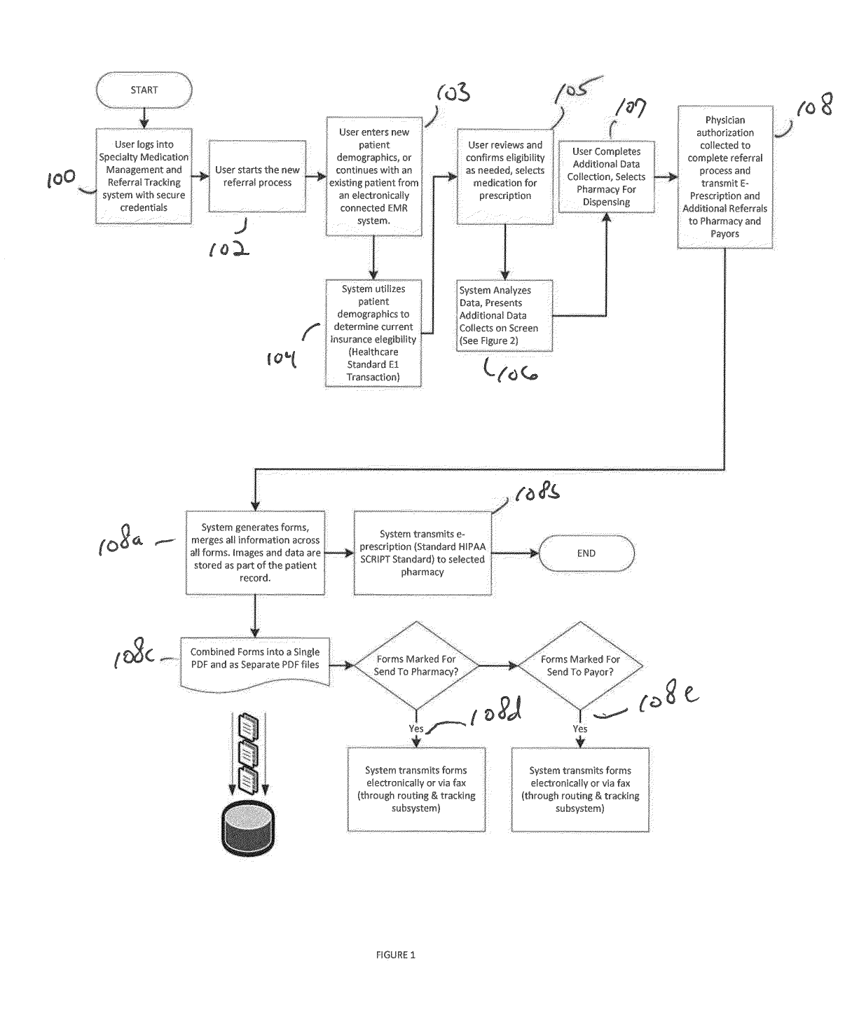

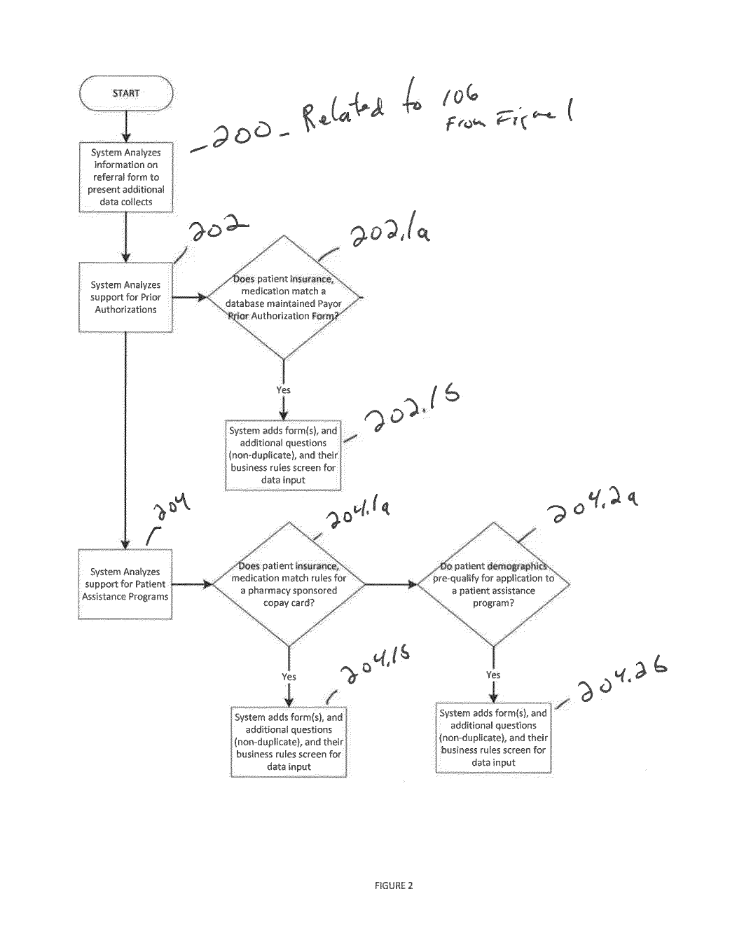

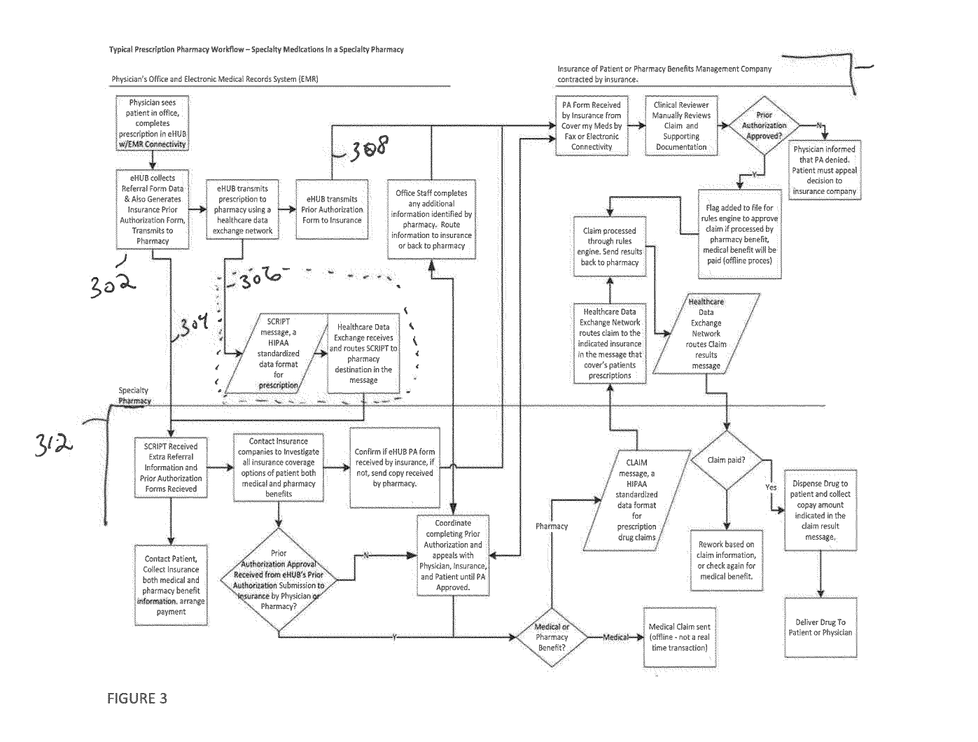

Turning to the Figures, FIG. 1 provides a flow diagram of the steps involved in using a specialty medication management and referral tracking system (SMMRTS) embodiment. In step 100, user logs into the system with secure credentials. In step 102, the user starts the new referral process. Step 103 involves entering new patient demographics, or continues with an existing patient information from an Electronic Medical Record (EMR) system that is communicating connected with SMMRTS system. In step 104, the system utilizes patient demographics to determine insurance eligibility (typically via a Healthcare Standard El Transaction). In other words, determining who the insurance carrier is for pharmacy benefits, and also which medications they cover, such as what tiers of medication. In step 105, the user reviews and confirms eligibility as needed, and selects medication for prescription. Step 106 involves analyzing the data, and presents additional data collection fields (such as shown in FIG. 2). Step 107 involves completion of additional data collection and selects pharmacy for dispensing. Step 108 involves collection of Physician authorization to complete referral process and transmit E-prescription and additional referrals to Pharmacy and Payors. See FIG. 3. Step 108 has several substeps: step 108a involves the generation of forms, merging of all information across all forms, and storage of images and data as part of the patient record. In step 108b, the system transmits e-prescription (Standard HIPAA SCRIPT Standard) to selected pharmacy. In step 108c, the forms from step 108a are combined into a single file (e.g. PDF) and as separate marked PDF files. Forms marked for sending to pharmacy are transmitted electronically or fax system to the target pharmacy per step 108d. Forms marked to sending to payor (insurance company) are transmitted electronically or fax to Payor per step 108e.

FIG. 2 sets forth a subroutine to determine whether collected information for a given prescription meets needed criteria. The system analyzes support for prior authorizations 202 and support for patient assistance programs 204. The authorization for 202 involves determining whether patient insurance medication matches a database maintained Payor Prior Authorization form per 202.1a. The database is accessible by the user If yes, the system adds form(s), and presents additional collection fields, if needed, per 202.1b.

The determination of support for patient assistance programs 204 may also involve determining whether the patient insurance medication matches rules for a pharmacy/industry recognized sponsored copay card per 204.1a. If yes, the system adds forms and presents additional data collection fields if needed, per 204.1b. Thus, inputting the information the system will generate a form that will allow a copay card to be issued along with the submission of the prescription referral. The system may also determine whether the patient demographics pre-qualifies the patient for application to a patient assistance program, per 204.2a (this would include manufacturer sponsored assistance based on a brand name drug as well as any assistance program based on previously collected meta data elements, and matching the embodiment's algorithm). If yes, the system presents additional data collection fields for inputting of information, per 204.2b. Thus, the inputting the additional non-duplicative information, will allow information to generate a form for patient assistance program and automatically generate enrollment in such patient assistance program.

FIG. 3 shows workflow of information using a system embodiment, designated as eHUB. Node 302 represents the output generated from steps 102-108 of FIG. 1. The transfer of forms to the pharmacy corresponds to the forms discussed above for step 108d. The eHUB transmits prescription to pharmacy also through a third-party healthcare data exchange network, such as SureScripts™ 306. This corresponds to step 108b discussed above. Sending both the forms and script message provides critical information that will allow the pharmacy to dispense the medication (in absence of this critical information, additional delays occur with the necessary back an forth communications required to collect and document this information at the pharmacy). The eHUB also sends forms to the Payor 308, which corresponds to step 108e discussed above. The other aspects of the workflow related to the pharmacy 312 and aspects relate to the payor 314 are self-explanatory and provided to illustrate the increases of efficiency enabled by the eHUB system.

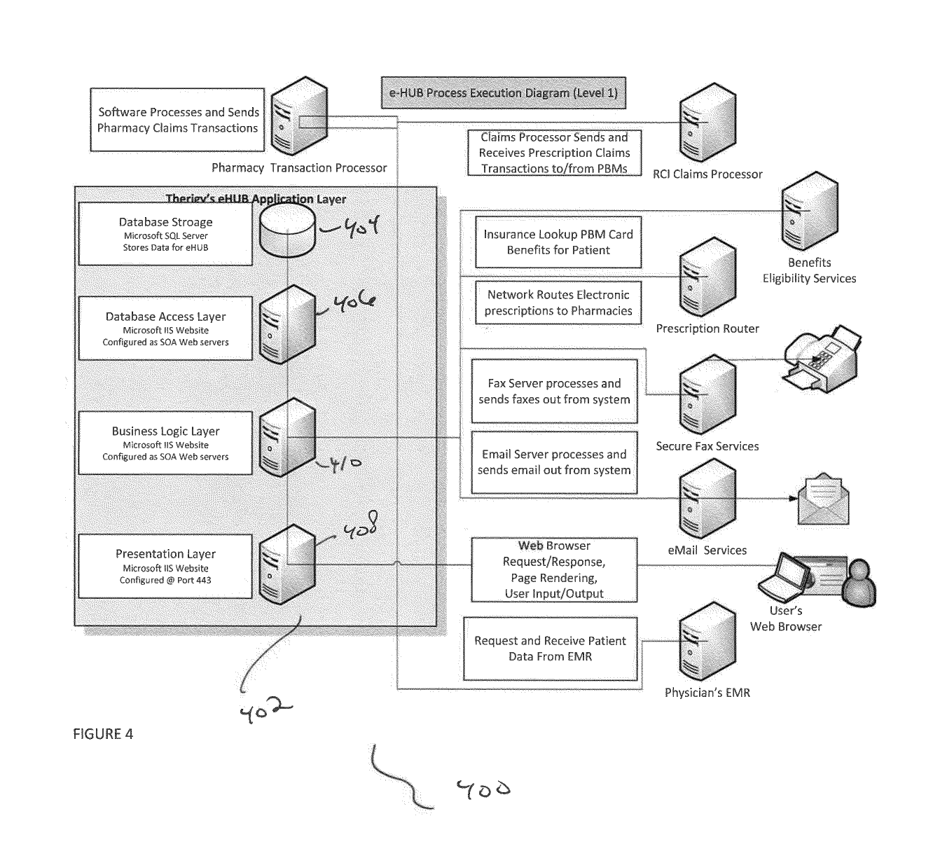

FIG. 4 shows an embodiment 400 of the multiple connections of different systems to which the system connects. The eHUB application layer 402 shows multiple sublayers, including database storage 404 which stores prior authorization forms and information. The database access sublayer 406 interacts with the database layer and conducts queries to the database to determine if patient information datasets require supportive information. The presentation sublayer 408 controls the input/output from the user to the eHUB application. The typical embodiment is a web based application. Alternate embodiments would support localized and decentralized storage for each device and user such as an application for an Apple “I” device or android device. In these applications the storage may be local to the device, and refreshed periodically from a master database. This embodiment is well known by practitioners as a master/slave, spoke and wheel, and other methods for data management strategies based on the need for concurrency and time based accuracy of data . The logic layer 410 controls the output of information to pharmacies and payors. Those skilled in the art will appreciate that the logic layer can be communicatingly connected to all or one or a portion of the items shown in FIG. 4.

Having described preferred embodiments of the invention, it will now become apparent to one skilled in the art that other embodiments incorporating their concepts may be used. These embodiments should not be limited disclosed embodiments, but should only be limited by the spirit and scope of the claims.

What is claimed is:

1. A system for submitting and/or tracking medication prescription referrals, the system comprising
a central computer unit communicatingly connected to a medical provider computer unit comprising a display and an input component associated therewith, and a pharmacy computer unit, and optionally an insurance provider computer unit, said central computer unit comprising a processing module and a memory component onto which a plurality of program code modules are stored; the plurality of program code modules comprising:
a first program code module for causing a field to be displayed on said display for inputting a first patient dataset;
a first optional program code module for causing said first patient dataset, or portion thereof, to be automatically populated from an electronic medical record system;
a second program code module for causing a medication field to be displayed on said display for inputting medication for prescription referral;
a third program code module for evaluating said first patient dataset for determining need for supportive patient dataset;
a fourth program code module for causing supportive patient dataset to be added to said first patient dataset;
a fifth program code module for causing a physician authorization collection field to be displayed on the display for inputting physician authorization; and
a sixth program code module for causing said central computer unit to transmit a prescription referral said pharmacy computer.

2. The system of claim 1, further comprising a database of payor prior authorization forms stored on a computer readable medium associated with said central computer, wherein said first patient dataset comprises patient insurance information and said evaluating function of said third program code module comprises querying said database of payor prior authorization forms to determine whether patient insurance information and medication match with a prior authorization form in said database.

3. The system of claim 1, further comprising a database of patient insurance medication match rules for a pharmacy sponsored copay card, wherein said first patient dataset comprises patient insurance information and said evaluating function of said third program code module comprises querying database of patient insurance medication match rules for a pharmacy sponsored copay card, and determining whether patient information dataset requires additional data to qualify for copay card.

4. The system of claim 1, wherein said transmitting of referral to said pharmacy comprises transmission via a healthcare data exchange network.

5. The system of claim 4, wherein said healthcare data exchange network is Surescripts.

6. The system of claim 1, further comprising a seventh program code module for causing said computer to generate a prior authorization form based on first patient dataset and supportive patient dataset .

7. The system of claim 6, further comprising an eighth program code module for causing said central computer to transmit said prior authorization form to said pharmacy computer unit.

8. The system of claim 7, wherein said pharmacy computer unit comprises a facsimile machine.

9. The system of claim 7, wherein said prior authorization form is transmitted to said pharmacy computer unit in the form of a facsimile transmission.

10. The system of claim 4, wherein said referral is transmitted to the pharmacy computer unit as a HIPAA SCRIPT.

11. The system of claim 7, wherein transmitting of referral to said pharmacy comprises transmission via a healthcare data exchange network.

12. The system of claim 11, wherein said referral transmitted via a healthcare data exchange network results in a HIPAA SCRIPT being transferred to said pharmacy computer unit.

13. The system of claim 1, further comprising a tenth program code module for causing said central computer to transmit a prior authorization form based on said first patient dataset and said patient supportive dataset to said payor computer unit.

14. The system of claim 13, wherein said payor computer unit comprises a facsimile machine.

15. The system of claim 14, wherein said prior authorization form is transmitted to said payor computer unit in the form of a facsimile transmission.

16. A method of tracking and managing medication prescription referrals, the method comprising
a central computer unit comprising a display and an input component associated therewith and communicatingly connected to a medical provider computer unit, an insurance provider computer unit and a pharmacy computer unit, said central computer unit comprising a processing module and a memory component onto which a plurality of program code modules are stored; the plurality of program code modules comprising:
inputting a first patient dataset into a central computer unit, said central computer unit communicatingly connected to a medical provider computer unit comprising a display and an input component associated therewith;
optionally populating said first patient dataset from an electronic medical record system associated with said medical provider computer unit;
displaying on said display a data collection field for inputting medication for prescription referral;
evaluating whether said first patient dataset needs a supportive patient dataset;
adding a supportive patient dataset to said first patient dataset, if needed;
displaying a physician authorization collection field on the display for inputting physician authorization; and
transmitting a prescription referral to said pharmacy computer unit.

17. The method of claim 16, wherein transmitting comprises transmitting a prior authorization form to said pharmacy computer unit.

18. The method of claim 16, wherein transmitting comprises transmitting an e-prescription via a healthcare data exchange network.

19. The method of claim 18, wherein said e-prescription comprises a HIPAA SCRIPT standard.

20. The method of claim 16, further comprising transmitting a prior authorization form based on said first patient dataset and said supportive patient dataset to a payer computer unit communicatingly connected to said central computer unit.
